(19) United States
(12) Patent Application Publication
(10) Pub. No.: US 2026/0036238 A1
(43) Pub. Date: Feb. 5, 2026

(54) MASS DAMPER ON TUBE

(71) Applicant: Hanon Systems, Daejeon (KR)

(72) Inventors: Petr Czyz, Hodslavice (CZ); Radek Macicek, Senov u Noveho Jicina (CZ); Kimiaki Ohno, Hiroshima (JP)

(21) Appl. No.: 19/198,271

(22) Filed: May 5, 2025

Related U.S. Application Data
(60) Provisional application No. 63/678,684, filed on Aug. 2, 2024.

(51) Int. Cl. F16L 55/04; B60H 1/00

(52) U.S. Cl. CPC F16L 55/041; B60H 1/00571; B60H 2001/006

(57) ABSTRACT

A mass damper includes a first portion having a first tube receiving surface defining a first tube opening configured to partially receive the tube therein, a second portion having a second tube receiving surface defining a second tube opening configured to partially receive the tube therein, and at least one protuberance protruding from the first tube receiving surface and/or from the second tube receiving surface. Each at least one protuberance is configured to deform a corresponding dimple into an outer surface of the tube upon compression of the tube between the first tube receiving surface and the second tube receiving surface with each at least one protuberance received within each corresponding dimple in a manner delimiting movement of the mass damper relative to the tube.

### CROSS-REFERENCE TO RELATED APPLICATION

This patent application claims priority to U.S. Provisional Patent Application Ser. No. 63/678,684, filed on Aug. 2, 2024, the entire disclosure of which is hereby incorporated herein by reference.

### FIELD OF THE INVENTION

The invention relates to a heating, ventilating, and air conditioning system for a vehicle and more particularly to a mass damper for a conduit of the heating, ventilating, and air conditioning system.

### BACKGROUND OF THE INVENTION

As is commonly known, vehicles typically include a heating, ventilating, and air conditioning (HVAC) system. The HVAC system maintains a temperature within a passenger compartment of the vehicle at a comfortable level for a passenger by providing a desired heating, cooling, and ventilation to the passenger compartment. The HVAC system conditions air flowing therethrough and distributes the conditioned air throughout the passenger compartment.

HVAC systems include conduit assemblies for providing fluid flow between adjacent components of an associated fluid conveying circuit, such as a coolant circuit or a refrigerant circuit associated with operation of the HVAC system. Each such conduit assembly may be comprised of a combination of fittings, polymeric hoses, and/or metallic tubes, depending on the circumstances. For example, an A/C line of a refrigerant circuit may include the aforementioned combination of components in directing the refrigerant into or out of the compressor of the associated refrigerant circuit. Such a conduit assembly may include the use of a combination of metallic (aluminum) tubes and polymeric hoses in communicating the refrigerant between the associated components of the refrigerant circuit.

In some circumstances, one of the conduit assemblies present within such a fluid conveying circuit includes a resonant frequency that is the same as or substantially similar to that of one of the fluid conveying components coupled to one of the ends of the one of the conduit assemblies. For example, in some circumstances the conduit assembly (suction A/C line) extending between the evaporator and the suction end of the compressor of a refrigerant circuit may include approximately the same resonant frequency as the evaporator coupled thereto. The consecutive combination of the conduit assembly and the adjacent component having the similar/same resonant frequency results in an unintended and unwanted vibration amplification effect that can be experienced as undesirable noise within the passenger compartment of the associated vehicle.

One efficient solution to this circumstance is to minimize the conduit assembly frequency relative to that of the adjacent component (such as the aforementioned evaporator of the refrigerant circuit) to prevent such a vibration (noise) amplification effect via the series combination of such same/similar resonant frequencies among adjacent flow components. Specifically, a mass damper device may be added to a segment of the conduit assembly comprised of one of the polymeric hoses to add a weight to the conduit assembly and, thus, change the vibration properties of the corresponding conduit assembly. As a result, noise, vibration, and harshness (NVH) that may be experienced within the passenger compartment is minimized. Because the hose segment receiving the mass damper is formed from a polymeric material, coupling the mass damper device to the hose segment is ideal due to the relatively high friction that can be formed between the mass damper device and the hose segment for affixing a position of the mass damper along the hose segment.

However, known mass damper devices disadvantageously contain many components, are not easily assembled to the associated conduit assembly, are typically limited to installation at only at a specific step of the assembly process (i.e. before crimping of a hose or a similar process), and do not allow for attachment of the mass damper device to the metallic and/or non-polymeric tube segments of the conduit assemblies that are devoid of relatively high-friction surfaces. Additionally, the polymeric hose segments of such conduit assemblies typically have a shorter length than the segments of metallic tubing utilized in combination therewith. With advancements and a desire for smaller vehicle packaging, minimizing the lengths of the conduit assemblies of the HVAC system, and in particular the polymeric hose segments of such conduit assemblies, is generally required where possible to allow for proper packaging of all components of the HVAC system within a provided space. Therefore, current mass dampers do not allow for manufacturing freedom and package design freedom as only those conduit assemblies having a polymeric hose segment are suitable for use with such mass dampers, and additionally only a limited length of each such conduit assembly having one of the polymeric hose segments disposed therealong is available for coupling to the presently available mass dampeners utilizing the described high-friction coupling process.

It would therefore be desirable to provide a mass damper for coupling to a metallic and/or non-polymeric tube of a conduit assembly of an HVAC system where noise, vibration, and harshness are minimized, manufacturing, case of installation, and design freedom is optimized, and a cost, package size, and a weight of the HVAC system are minimized.

### SUMMARY OF THE INVENTION

In accordance and attuned with the present invention, a mass damper for coupling to a tube of a conduit system of the HVAC system where noise, vibration, and harshness are minimized, manufacturing, case of installation, and design freedom is optimized and a cost, package size, and a weight of the HVAC system are minimized, has surprisingly been discovered.

According to an embodiment of the present invention, a mass damper for coupling to a tube comprises a first portion having a first tube receiving surface defining a first tube opening configured to partially receive the tube therein, a second portion having a second tube receiving surface defining a second tube opening configured to partially receive the tube therein, and at least one protuberance protruding from the first tube receiving surface and/or from the second tube receiving surface. The at least one protuberance is configured for reception within a dimple formed in an outer surface of the tube to limit movement of the mass damper relative to the tube.

According to another embodiment of the present invention, a conduit assembly includes at least one tube segment and a mass damper coupled to the at least one tube segment. The mass damper comprises a first portion having a first tube receiving surface defining a first tube opening partially receiving the at least one tube segment therein, a second portion including a second tube receiving surface defining a second tube opening configured to partially receive the at least one tube segment therein, and at least one protuberance protruding from the first tube receiving surface and/or from the second tube receiving surface with the at least one protuberance configured for reception within a dimple formed in an outer surface of the at least one tube segment to limit movement of the mass damper relative to the at least one tube segment.

A method of coupling the mass damper to a tube is also disclosed according to the present invention. The method comprises the steps of: providing the mass damper, the mass damper including a first portion having a first tube receiving surface, a second portion having a second tube receiving surface, and at least one protuberance protruding from at least one of the first tube receiving surface and/or the second tube receiving surface; disposing the tube between the first tube receiving surface and the second tube receiving surface; and moving the first portion towards the second portion to cause the at least one protuberance to deform an outer surface of the tube to include a dimple therein, the dimple receiving the at least one protuberance therein to delimit movement of the mass damper relative to the tube.

### BRIEF DESCRIPTION OF THE DRAWINGS

The above, as well as other objects and advantages of the invention, will become readily apparent to those skilled in the art from reading the following detailed description of an embodiment of the invention when considered in the light of the accompanying drawing which:

FIG. 1 is a side elevational view of a conduit assembly having a mass damper installed to a tube according to an embodiment of the present invention;

FIG. 2 is a front perspective view of the mass damper when in an open configuration;

FIG. 3 is a right-side perspective view of the mass damper when in a closed configuration for coupling the mass damper to the tube;

FIG. 4 is a fragmentary cross-sectional view taken along a plane perpendicular to the axial direction of the mass damper while showing the interacting surfaces of the mass damper and the tube immediately prior to the mass damper deforming the tube during a process of adjusting the mass damper from the open configuration to the closed configuration;

FIG. 5 is a fragmentary cross-sectional view taken from the perspective of FIG. 4 while showing the interacting surfaces of the mass damper and the tube following completion of the adjustment of the mass damper from the open configuration to the closed configuration; and

FIG. 6 is a fragmentary cross-sectional view taken along a plane parallel to the axial direction of the mass damper while showing the interacting surfaces of the mass damper and the tube following completion of the adjustment of the mass damper from the open configuration to the closed configuration.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

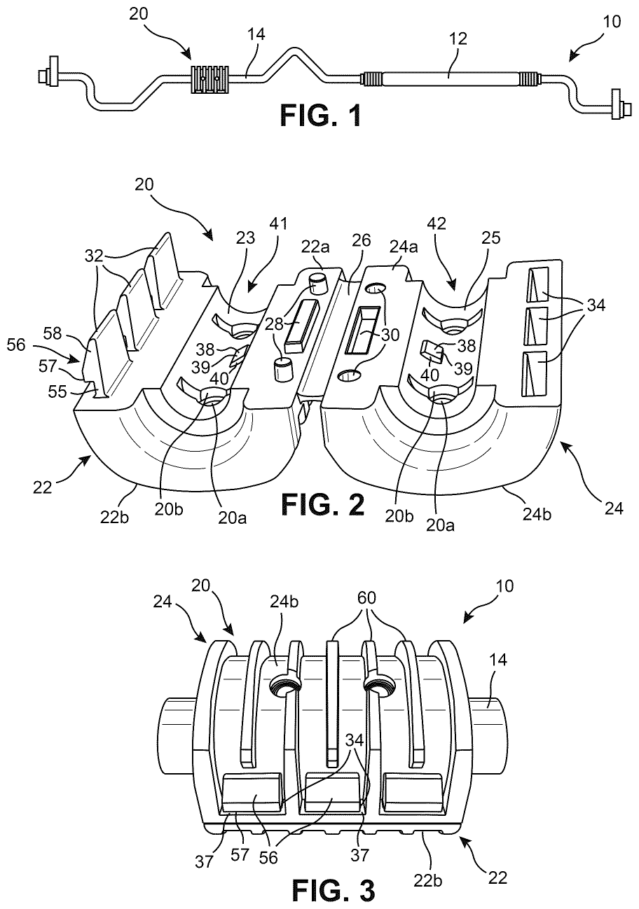

FIG. 1 illustrates a conduit assembly 10 for use with a heating, ventilating, and air conditioning (HVAC) system or climate control system according to an embodiment of the present disclosure. The conduit assembly 10 is configured to convey a fluid such as a refrigerant or coolant therethrough, for example. The conduit assembly 10 may be utilized within a system where the conduit assembly 10 experiences a cyclic load such as may be caused by pulsations of the fluid, wherein such pulsations may be generated by the cyclic nature of the compressors or pumps that are associated with pressurizing the fluid of such a system. The conduit assembly 10 may accordingly be associated with a mass damper 20 configured to alter a mass distribution of the conduit assembly 10 such that the conduit assembly 10 reacts differently to being loaded cyclically upon a coupling of the mass damper 20 to the conduit assembly 10. More specifically, the addition of the mass damper 20 to the conduit assembly 10 may result in a resonant frequency of the conduit assembly 10 being altered away from an expected load frequency experienced by the conduit assembly 10 or away from a resonant frequency of an adjacent component of the fluid conveying system. This alteration of the resonant frequency of the conduit assembly 10 thereby prevents an incidence of noise, vibration, and harshness amplification along the conduit assembly 10 as may be caused by the operation of the fluid conveying system or by the similarities in resonant frequencies across multiple components forming a flow path for the fluid along the corresponding fluid conveying system. According to one possible implementation of the mass damper 20, the conduit assembly 10 is provided as the A/C (suction) line of a refrigerant circuit connecting a downstream end of an evaporator of the refrigerant circuit to an inlet end (suction port) of a compressor of the refrigerant circuit and the mass damper 20 is installed to the conduit assembly 10 in order to ensure that a resonant frequency of the conduit assembly 10 is not the same as that of the evaporator in a manner leading to vibration amplification as the refrigerant passes through the evaporator and then the conduit assembly 10.

The conduit assembly 10 includes a hose or hoses 12 and a tube or tubes 14. The hose(s) 12 may be formed at least partially from a polymeric material, including along the exterior surfaces thereof, whereas the tube(s) 14 may be formed primarily or exclusively from a metallic material, including along the exterior surfaces thereof. For example, the tube(s) 14 may be formed from aluminum that is exposed at an exterior of each of the aluminum tube(s) 14, wherein the exposed aluminum includes a lower co-efficient of friction in comparison to the polymeric material forming the exterior surfaces of the hose(s) 12. The conduit assembly 10 is shaped, structured, and assembled according to a package design of the vehicle, and hence may include the corresponding hose(s) 12 and tube(s) 14 in any corresponding combination and configuration for accommodating such a package design. The simplified configuration shown in FIG. 1 is thus in no way limiting to the present invention.

The conduit assembly 10 of FIG. 1 includes the mass damper 20 according to the present invention coupled to one of the tubes 14 present along the length of the conduit assembly 10. The mass damper 20 can be positioned at any axial position along any of the tubes 14 forming the conduit assembly 10, as desired. Although FIG. 1 is only one non-limiting example of a configuration of the conduit assembly 10, it may be common for the conduit assembly 10 to include the total length of all combined segments of the tubes 14 to exceed a total length of all combined segments of the hoses 12, and/or for the longest segment of the tubes 14 to exceed the length of the longest segment of the hoses 12 with respect to certain applications of the conduit assembly 10, such as where the conduit assembly 10 is utilized as the suction A/C line connecting the evaporator to the compressor as discussed above. This increased total length of the tubes 14 and/or increased length of the longest segment of the tubes 14 in comparison to the total length of the hoses 12 and/or the length of the longest of the hoses 12 leads to an advantage of the present invention in that the number of available axial positions corresponding to possible positions of the mass damper 20 are increased relative to the use of a mass damper specifically configured for a high-friction connection to a polymeric outer surface of a corresponding hose, as proposed by the prior art.

The mass damper 20 is generally comprised of a semi-annular first portion 22 and a semi-annular second portion 24 that are hingedly coupled to one another via a hinge 26 extending therebetween, wherein the hinge 26 generally defines an axis of rotation (pivoting) of each of the portions 22, 24 towards or away from one another. The hinge 26 is configured to facilitate a rotational adjustment of the mass damper 20, and more specifically rotational adjustment of each of the portions 22, 24 thereof, between an open configuration and a closed configuration in coupling the mass damper 20 to a corresponding segment of the tube 14.

The mass damper 20 of the present invention may be formed from a plurality of different materials forming different layers thereof. Specifically, the mass damper 20 may include each of the respective portions 22, 24 thereof formed from an inner disposed core body 20a that is coated or covered with an exterior disposed cover 20b. Hence, when approached from an exterior, the mass damper 20 may include at least an exposed layer formed by the cover 20b followed by an underlying layer formed by a respective one of the core bodies 20a.

The cover 20b may be common to both of the portions 22, 24 with a segment of the cover 20b extending between the respective portions 22, 24 forming the hinge 26 of the mass damper 20. That is, the segment of the cover 20b corresponding to the first portion 22, the segment of the cover 20b corresponding to the second portion 24, and the portion of the cover 20b forming the hinge 26 may all be integrally or monolithically formed from a common material comprising a common structure that further encapsulates and covers the core bodies 20a.

Each core body 20a may be formed from a relatively dense material in comparison to the cover 20b disposed thereover such that the combination of the core bodies 20a comprises the majority of the mass of the mass damper 20. Each core body 20a may be formed from a metallic material while the cover 20b may be formed from a polymeric material that is molded over the metallic core bodies 20a when the core bodies 20a are suitably positioned relative to one another (such as when in the position shown in FIG. 2), wherein such a molding process forms the hinge 26 via a flow of molding material between the portions 22, 24. The material forming the cover 20b may also be selected to be relatively hard and strong upon formation into the configuration shown and described herein such that the cover 20b is able to deform the metallic material (aluminum in the present example) forming the tube 14 according to one method of installing the mass damper 20 thereto, as explained in greater detail hereinafter. In some embodiments, the core 20a may be formed from zinc and the cover may be formed from PA66 (alternatively referred to as nylon 66 or polyamide 6.6), as one non-limiting combination of suitable materials in forming the mass damper 20.

Although the hinge 26 is described as being a monolithically formed extension of the cover 20b between the two portions 22, 24, it should be apparent that the mass damper 20 may be produced to include a different construction of the hinge 26 from that described without necessarily departing from the scope of the present invention. For example, the hinge 26 may be provided as a third, separate component in addition to the portions 22, 24 or the hinge 26 may be formed by cooperating structures associated with each of the portions 22, 24, as desired. However, such alternative constructions may include the use of more parts and the use of more complex, costly, and/or time-consuming manufacturing processes in comparison to the molding process contemplated in forming the hinge 26, hence the molded formation of the hinge 26 as a portion of the cover 20b may be preferable in comparison to the use of a cooperating structures.

The first portion 22 includes an inner face 22a and an outer face 22b while the second portion 24 includes an inner face 24a and an outer face 24b. The inner face 22a of the first portion 22 includes a first tube receiving surface 23 defining a first tube receiving opening 41 configured to partially receive the tube 14 therein. The inner face 24a of the second portion 24 includes a second tube receiving surface 25 defining a second tube receiving opening 42 configured to partially receive the tube 14 therein. The first tube receiving opening 41 and the second tube receiving opening 42 each extend in an axial direction of the mass damper 20 arranged parallel to the axis of rotation formed by the hinge 26 during adjustment of the mass damper 20 between the open and closed configurations thereof.

In the present embodiment, the tube 14 is substantially cylindrical in shape, and thus includes a circular cross-sectional shape. The first tube receiving surface 23 (and hence the corresponding first tube receiving opening 41) may thus include a semi-cylindrical shape with a semi-circular cross-section configured to receive a semi-cylindrical first portion of the tube 14 having a semi-circular cross-section (corresponding to a first diametric half of the tube 14) while the second tube receiving surface 25 (and hence the corresponding second tube receiving opening 42) may similarly include a semi-cylindrical shape with a semi-circular cross-section configured to receive a semi-cylindrical second portion of the tube 14 having a semi-circular cross-section (corresponding to a second diametric half of the tube 14 opposite the first diametric half). However, it is conceivable that the tube 14 may include a contrary cross-sectional shape about a periphery thereof, such as including an elliptical (non-circular) peripheral shape, wherein each of the tube receiving surfaces 23, 25 may accordingly be adjusted to include semi-elliptical shapes that correspond to the selected shape of the tube 14, as one possible example.

A diameter across each of the tube receiving openings 41, 42 (as measured between the outer edges of the respective tube receiving surfaces 23, 25) as well as a radius of curvature of each corresponding tube receiving surface 23, 25 may be selected to be substantially similar to or slightly larger than the diameter and radius of curvature of the tube 14 to allow for reception of the tube 14 within a substantially cylindrical through-hole 45 (shown in FIG. 5) of the mass damper 20 formed by the cooperation of each of the tube receiving openings 41, 42 when the mass damper 20 is in the closed configuration thereof. An amount of play normally present between the outer surface of the tube 14 and the semi-cylindrical surfaces 23, 25 defining the through-hole 45 may be selected to account for expected variations in thermal expansion that may occur between the mass damper 20 and the tube 14 during operational use of the conduit assembly 10, which may occur due to the potential use of different materials in forming the facing surfaces of the mass damper 20 and the tube 14. Regardless of the amount of play provided to account for the expected thermal expansion, the reception of the cylindrical segment of the tube 14 within the cylindrically shaped through-hole 45 of the same or similar diameter results in a delimiting of the ability of the mass damper 20 to rotate relative to the segment of the tube 14 received within the through-hole 45 with respect to axes arranged perpendicular to the axial direction of the segment of the tube 14, and further results in a delimiting of the ability of the mass damper 20 to move laterally relative to the segment of the tube 14 with respect to all radial directions of the tube 14.

The open configuration of the mass damper 20 may include the inner face 22a of the first portion 22 and the inner face 24a of the second portion 24 angularly displaced from one another with respect to rotational positions of each of the portions 22, 24 about the hinge 26 such that the inner faces 22a, 24a are not in contact with each other and the portions 22, 24 are not positionally affixed to each other outside of the rotatable connection provided by the hinge 26 extending therebetween, thereby allowing for the inner faces 22a, 24a of the portions 22, 24 to be rotated about the hinge 26 to a position allowing for lateral entry of the tube 14 through a gap present between the inner faces 22a, 24a at a position along the mass damper 20 opposite the axis of rotation provided by the hinge 26. Upon production thereof, the mass damper 20 may be provided initially in the example of the open configuration shown in FIG. 2, wherein the inner faces 22a, 24a of the portions 22, 24 and the hinge 26 are all arranged in a substantially co-planar configuration.

In contrast, the closed configuration of the mass damper 20 includes an engagement of the inner face 22a of the first portion 22 with the inner face 24a of the second portion 24 via rotation of the first portion 22 and the second portion 24 towards each other about the hinge 26, whereby the engagement present between the inner faces 22a, 24a is configured to affix a position of the first portion 22 relative to the second portion 24 outside of the rotatable connection provided by the hinge 26. The closed configuration of the mass damper 20 also includes the semi-annular shapes of each of the respective portions 22, 24 cooperating with each other to result in the mass damper 20 taking on a closed annular shape capable of receiving the tube 14 therethrough via the formation of the through-hole 45 upon the mass damper 20 reaching the closed configuration. As explained in greater detail hereinafter, the closed configuration of the mass damper 20 according to the present invention also includes an affixing of the axial position of the mass damper 20 relative to the segment of tube 14 around which the mass damper 20 is installed via the use of movement delimiting engagement occurring between the mass damper 20 and the tube 14.

When the mass damper 20 is initially provided in the open configuration shown with respect to FIG. 2, the adjustment of the mass damper 20 from the open configuration to the closed configuration requires 180 degrees of combined relative rotation between the inner faces 22a, 24a as well as a curving, bending, or folding of the hinge 26 along one or more axes extending in the axial direction of the mass damper 20. The hinge 26 may be formed to include an excess flow of material for reinforcing the hinge 26 in a manner wherein the process of pivoting of the portions 22, 24 relative to the hinge 26 does not result in an undesirable fracturing of the hinge 26 via the described curving, bending, or folding thereof, thereby ensuring proper rotational guidance by the hinge 26 in adjusting the portions 22, 24 towards the closed configuration thereof. Additionally, the continued presence of the hinge 26 extending between the portions 22, 24 ensures that the portions 22, 24 are always paired in a manner reducing the number of parts associated with installation and/or maintenance of the mass damper 20.

Vibration minimization between the portions 22, 24 is achieved by a combination of a at least one lock and counter hole coupling and at least one tab and slot coupling. The at least one lock and counter hole coupling may include a plurality of projections 28 formed on the first portion 22 each arcuately aligning (during rotational adjustment of the mass damper 20 about the hinge 26 towards the closed configuration thereof) with one of a plurality of holes 30 formed on the second portion 24. When in the closed configuration of the mass damper 20, each of the projections 28 engages the corresponding one of the holes 30 by a snap-fit or friction fit engagement to prevent relative movement between the portions 22, 24, thereby preventing vibration formation via a loose-fitting rattling effect between such features. In the present embodiment, the projections 28 include a pair of cylindrical projections and a centrally disposed rectangular cuboid projection, but it should be apparent to one skilled in the art that any variety of different shapes and configurations of the projections 28 and corresponding holes 30 may be utilized while remaining within the scope of the present invention so long as the engaging features are press or friction-fit to one another in the manner described.

The tab and slot coupling includes a plurality of tabular members 32 formed on and projecting from the inner face 22a of the first portion 22 arcuately aligning with a plurality of slots 34 recessed into the inner face 24a of the second portion 24 and configured to receive and engage the tabular members 32 when the mass damper 20 is adjusted to the closed configuration thereof. Each of the tabular members 32 may include a base segment 55 and an arm 56 having a shoulder 57 and a tapered portion 58. The base segment 55 of each tabular member 32 connects the arm 56 to the planar portion of the inner face 22a and is provided to be resiliently flexible such that the arm 56 can flex laterally about an axis extending in the axial direction of the mass damper 20. The shoulder 57 of each tabular member 32 is formed by a portion of the corresponding tabular member 32 projecting laterally outwardly from the base segment 55 and then outwardly away from the inner face 22a. The tapered portion 58 extends from the shoulder 57 and includes a decreasing thickness when progressing away from the planar portion of the inner surface 22a.

Each of the slots 34 extends through the second portion 24 from the inner face 24a to the outer face 24b thereof while passing through a laterally outwardly extending flanged segment 37 of the second portion 24. During adjustment of the mass damper 20 from the open configuration to the closed configuration thereof, the arm 56 of each of the tabular members 32 enters a corresponding one of the slots 34 and the tapered portion 58 of each of the tabular members 32 engages a surface defining the corresponding one of the slots 34 in a manner causing each of the tabular members 32 to flex inwardly about the respective base segment 55 thereof for passage of the arm 56 through the corresponding slot 34. Once the shoulder 57 has passed fully through the slot 34 to the outer face 24b of the second portion 24, the arm 56 is able to resiliently flex outwardly such that a ledge formed by the flanged segment 37 provides interference with the shoulder 57 for preventing removal of the corresponding tabular member 32 from the corresponding slot 34, thereby establishing a snap-fit connection. However, in other embodiments the tabular members 32 and the slots 34 may instead utilize a friction-fit or other interlocking fit for preventing undesired disassembly of the mass damper 20 upon reaching the closed configuration thereof, as desired, without necessarily departing from the scope of the present invention.

The hinge 26 may be formed to include some degree of torsional resiliency such that the portions 22, 24 attempt to return back towards the open configuration upon reaching the closed configuration, and this tendency of the mass damper 20 to return to the open configuration may facilitate continued contact between the shoulders 57 and the flanged segment 37 such that relative movement (vibration, rattling, etc) is delimited between the portions 22, 24 of the mass damper 20 when in the closed configuration. As shown in FIG. 3, each of the arms 56 is exposed along the outer face 24b of the second portion 24 in a manner wherein the snap-fit connection may be removable via a pressing of each of the arms 56 inwardly for aligning each of the arms 56 with the corresponding one of the slots 34 for passage therethrough when adjusting the mass damper 20 from the closed configuration back to the open configuration.

The outer faces 22b, 24b of the portions 22, 24 may include circumferentially extending ribs or other reinforcing members 60 formed therein for strengthening the mass damper 20 from undesired deformation, such as may occur during a process of closing the mass damper 20 around the tube 14 where external forces are applied to the portions 22, 24 in rotating the portions 22, 24 towards the closed configuration.

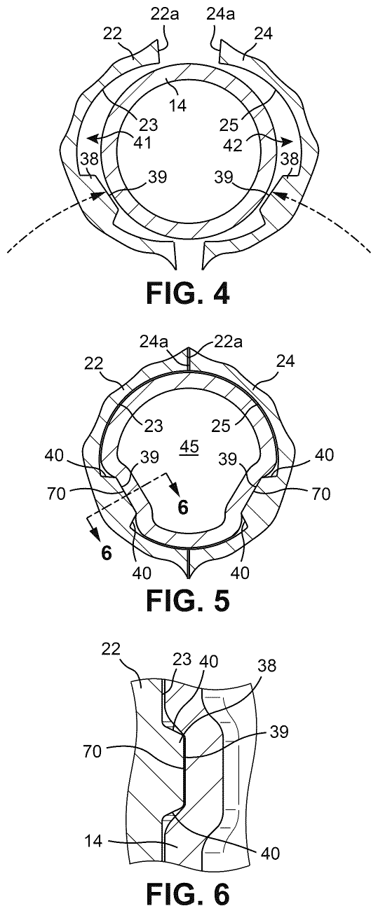

It is desired to maintain the mass damper 20 coupled to the tube 14 of the conduit assembly 10 at the selected axial position along the tube 14 for a life of the conduit assembly 10. Therefore, in order to maximize friction and minimize movement of the mass damper 20 with respect to the tube 14, at least one dimple forming protuberance or pin 38 projects outwardly from at least one of the first tube receiving surface 23 and/or the second tube receiving surface 25. Each of the protuberances 38 is configured to form a corresponding dimple 70 (FIGS. 4-6) in an outer surface of the tube 14 so relative axial or rotational movement between the mass damper 20 and the tube 14 is minimized. Specifically, each of the protuberances 38 is configured to deform the outer surface of the segment of the tube 14 passing through the mass damper 20 during a process of adjusting the mass damper 20 from the open configuration to the closed configuration in the manner depicted by FIGS. 4 and 5.

In the present embodiment, a first one of the protuberances 38 projects from within the first tube receiving surface 23 and a second one of the protuberances 38 projects from within the second tube receiving surface 25, wherein the first and second ones of the protuberances 38 include the same positions along the axial direction of the mass damper 20 for engaging the tube 14 at different circumferential positions thereof with respect to the same axial position along the tube 14. These different circumferential positions correspond to deforming the tube 14 inwardly in different radial directions that at least partially oppose each other for compressing the tube 14 inwardly in the direction of closure of the portions 22, 24 towards each other, wherein such direction of closure is perpendicular to the seam present between the engaging inner faces 22a, 24a as depicted in FIG. 5 showing the closed configuration of the mass damper 20.

Each of the protuberances 38 is shown as including a distal surface 39 and a plurality of side surfaces 40 connecting the distal surface 39 to the corresponding tube receiving surface 23, 25 from which the corresponding protuberance 38 projects. Each transition of one of the side surfaces 40 to another of the side surfaces 40, to the corresponding tube receiving surface 23, 25, and/or to the distal surface 39 may include an arcuate shape to prevent an incidence of stress risers occurring within the tube 14 or within one of the protuberances 38 during or following deformation of the tube 14. The surfaces 39, 40 are arranged in a substantially truncated pyramidal shape where each of the sides surfaces 40 is inclined outwardly when extending away from the periphery of the distal surface 39, which may be substantially square or rectangular in shape, and towards the corresponding tube receiving surface 23, 25. This results in each of the protuberances 38 having an inward taper towards the distal surface 39 thereof when projecting away from the corresponding tube receiving surface 23, 25 to aid each of the protuberances 38 in deforming the tube 14 in a manner preventing the formation of undesirably large bends in the tube 14 as a result of the prescribed deformation, which again avoids the formation of undesirably large stress risers within the tube 14. That is, the incline and corresponding taper of the side surfaces 40 may be selected to not be so steep as to form an undesirably sharp bend in the tube 14 while also being steep enough to provide the necessary interference for preventing relative movement between the tube 14 and the mass damper 20.

The distal surface 39 is arranged perpendicular to the radial direction of the corresponding tube receiving surface 23, 25 at the angular position of a center of the corresponding protuberance 38 along the circular cross-sectional shape formed by each of the respective tube receiving surfaces 23, 25. Each of the protuberances 38 accordingly projects radially inwardly with respect to the circular profile of the corresponding tube receiving surface 23, 25, which also corresponds to projecting radially inwardly towards the central axis of the cylindrical tube 14 and towards the central axis of the cylindrical through-hole 45 with respect to the closed configuration of the mass damper 20 depicted in FIG. 5.

A height of each of the protuberances 38, which is measured in the radial direction of the corresponding tube receiving surface 23, 25 and corresponds to the radial distance the distal surface 39 is spaced apart from the semi-circular shape prescribed by the corresponding tube receiving surface 23, 25 at the angular position for which the height is being measured, is also selected to ensure that a desired interaction is present between each of the protuberances 38 and the tube 14 for accomplishing the objectives of the present invention. As can be seen in FIGS. 4 and 5, the height of each of the protuberances 38 is maximized at the angular position corresponding to the center of the distal surface 39, and thus the height of each of the protuberances 38 as described herein may refer to selection of this maximized height. The (maximum) height of each of the protuberances 38 may be selected to be within a desired range. If the height of each of the protuberances 38 is greater than the range, then the height could once again lead to excessive stress concentrations being present within the plastic cover 20b of the mass damper 20 and/or the tube 14 during and after adjustment of the mass damper 20 to the closed configuration thereof, as may be caused by the protuberances 38 forming a large bend in the tube 14 via the excessive radial inward deformation thereof. If the height of the protuberances 38 are less than the desired range, then potential exists for the mass damper 20 to move relative to the tube 14 during vibration of the conduit assembly 10 as well as temperature and load changes experienced by the vehicle. It is also desirable to maintain the height of the protuberances 38 within the prescribed range to ensure that the closing forces necessary in adjusting the mass damper 20 to the closed configuration while deforming the tube 14 are not excessively high, thereby allowing for greater flexibility to performing such a closure process, such as by manual or automated methods.

As mentioned previously, the material forming the cover 20b, and thus each of the protuberances 38, may include a different co-efficient of thermal expansion in comparison to the material forming the tube 14 such that there is relative movement between the tube 14 and each of the protuberances 38 upon both the tube 14 and the protuberances 38 undergoing a temperature change from the temperature present within the conduit assembly 10 when the tube 14 is initially deformed by the protuberances 38. For example, the tube 14 may shrink diametrically relative to the through-hole 45 formed by the tube receiving surfaces 23, 25 as a result of such a temperature change, which may lead to the removal of one of the protuberances 38 from the corresponding dimple 70 if the height of the protuberance 38 is not sufficient to accommodate such shrinkage in the radial direction for remaining within the corresponding dimple 70. The maximum height of each of the protuberances 38 may accordingly be selected to be at least as great as the radial distance of relative shrinkage present between the outer surface of the tube 14 and the through-hole 45 with respect to a maximum change in temperature experienced by the conduit assembly 10 during operational use thereof, or alternatively at least as great as the diametric distance of relative shrinkage present between the outer surface of the tube 14 and the through-hole 45 with respect to a maximum change in temperature experienced by the conduit assembly 10 during operational use thereof. That is, for any temperature the conduit assembly 10 is exposed to during operational use thereof, including maximum and minimum temperatures to which the tube 14 along the conduit assembly 10 is expected to be exposed during such operational use, the height of each of the protuberances 38 is selected to ensure that the radial or diametric distance of separation between a corresponding pairing of a protuberance 38 and a dimple 70, as caused by the relative shrinkage between the tube 14 and the mass damper 20 resulting from the varying thermal expansions thereof, does not exceed the selected (maximum) radial height of the protuberance 38 such that removal of the protuberance 38 from the paired dimple 70 is prevented.

As can be seen most clearly in FIGS. 4 and 5, each of the protuberances 38 is disposed at an angular position along the corresponding semi-circular tube receiving surface 23, 25 that is biased towards the outer edge of the corresponding tube receiving surface 23, 25 disposed towards the hinge 26 and not towards the outer edge of the corresponding tube receiving surface 23, 25 having the tabular members 32 or slots 34. This biasing of the protuberances 38 towards the outer edge adjacent the hinge 26 results in the center of each of the protuberances 38 being offset from an angular position half-way between the outer edges of the corresponding tube receiving surface 23, 25. In the present embodiment, the center of each of the protuberances 38 is offset about 60 degrees from the outer edge of the corresponding tube receiving surface 23, 25 adjacent the hinge 60, and each of the protuberances extends along a range corresponding to angular displacements from the outer edge adjacent the hinge 26 of about 40 degrees to 80 degrees with respect to the outermost edges of the side surfaces 40.

The disclosed offsetting of the protuberances 38 from the central position along the corresponding tube receiving surface 23, 25 and towards the hinge 26 provides a benefit in that the closing force required in adjusting the mass damper 20 from the open configuration to the closed configuration while deforming the tube 14 between the opposing portions 22, 24 may be applied with a mechanical advantage due to the closing force being applied to the portions 22, 24 at a distance further from the axis of rotation provided by the hinge 26 than the engagement present between the tube 14 and each of the protuberances 38, thereby presenting a nut-cracker like lever mechanism. For example, diametrically opposing forces applied to the portions 22, 24 in directions perpendicular to the seam present between the inner faces 22a, 24a (as depicted in FIG. 5) and towards the central axis of the tube 14 are applied to the portions 22, 24 at radial positions distal to the corresponding protuberances 38 to appreciate such a mechanical advantage in pivoting the portions 22, 24 about the hinge 26.

The biasing of the protuberances 38 towards the hinge 26 along each of the corresponding tube receiving surfaces 23, 25 also does not negatively affect the manner in which each of the protuberances 38 penetrates the tube 14 since the tangential directions of closing of each of the protuberances 38 (shown by broken lines in FIG. 4) are generally towards the central axis of the tube 14 throughout the process of the protuberances 38 deforming the tube 14. In contrast, formation of the protuberances 38 beyond the center of the corresponding tube receiving surface 23, 25 and towards the tabular members 32/slots 34 may form the corresponding dimples 70 in the tube 14 in an undesirable manner since the tangential directions of the protuberances 38 would be away from the central axis of the tube 14 and the direction of radial inward projection of the protuberances 38 upon fully penetrating the tube 14.

As shown in FIG. 6, the deformation of the tube 14 by the depicted protuberance 38 results in the formation of a corresponding dimple 70 that includes a radial depth sufficient to delimit axial motion of the mass damper 20 relative to the tube 14 via engagement between the side surfaces 40 and facing surfaces of the dimple 70. As shown in FIG. 5, each of the protuberances 38 also delimits rotation of the mass damper 20 about the central axis of the tube 14 via interference present between the side surfaces 40 and facing surfaces of the dimples 70 in the circumferential direction of the tube 14.

The present invention is not limited to the configuration of the protuberances 38 as shown throughout FIGS. 4-6. For example, each of the tube receiving surfaces 23, 25 may include any number of the protuberances 38 or only one of the tube receiving surfaces 23, 25 may include one of the protuberances 38, as desired, so long as the protuberances 38 include the necessary depth for delimiting movement of the mass damper 20 in the manner described. The protuberances 38 may also be disposed at contrary angular positions along the respective tube receiving surfaces 23, 25 from those shown and described, and any angular displacements that are present need not be the same between all protuberances 38 associated with either of the portions 22, 24. The protuberances 38 are also not limited to the disclosed truncated pyramidal shape, as alternative perimeter shapes and alternative tapers may be utilized while still forming the necessary facing surfaces between the protuberances 38 and the dimples 70 via penetrative deformation of the tube 14 in delimiting motion of the mass damper 20 along each of the axes as described herein.

The present invention provides numerous advantages in comparison to the known prior art. The described configuration of the mass damper 20 provides a one-part solution that is ideal for use in a high output molding process, thereby resulting in cost effectivity. The mass damper 20 according to this disclosure does not need any additional part like a clap, rubber grommet, or screws to fix the mass damper to the conduit assembly 10, which permits the manufacturing process to be simpler, quicker, more easily automated, and more cost efficient than the processes utilized in forming the mass dampers of the prior art.

The assembly process of closing the mass damper 20 around the tube 14 can also be performed at any stage of the production of the conduit assembly 10, thereby providing improved manufacturing freedom. This contrasts the prior mass damper designs, which typically utilize a clamp that requires the mass damper to be assembled before the corresponding hose is subsequently crimped, which in turn results in the need for the mass damper to be installed over the hose prior to application of the clamp. The mass damper 20 as disclosed significantly reduces the amount of manual labor required in assembling the mass damper 20 in comparison to the mass dampers of the prior art, and can also be advantageously implemented in an automated manufacturing process.

The ability to couple the mass damper 20 to positions along the conduit assembly 10 comprising one of the metallic tubes 14 also significantly improves the design freedom offered in adjusting the mass distribution of the conduit assembly 10 in comparison to mass dampers only capable of connection to polymeric hoses via high-friction couplings, and especially when the length of such tubes 14 is individually or collectively greater than that of any corresponding hoses 12 along the conduit assembly 10. The expansion of positions suitable for installation of the mass damper 20 along the conduit assembly 10 to include the metallic segments of the tubes 14 accordingly improves the probability that a position can be found along the conduit assembly 10 where the acoustic characteristics of the conduit assembly 10 can be adequately modified while also being spatially capable of receiving the mass damper 20 therearound in accommodating the packaging space available within the corresponding vehicle (or related housing if the mass damper 20 is utilized in a contrary application) along the path way of the conduit assembly 10.

Lastly, the described construction of the mass damper 20 allows for the mass damper 20 to be produced to include desirable thermal and corrosion resistance. For example, the use of a polymeric cover material as the outermost layer of the mass damper 20 may allow for the selection of the cover material based on such characteristics of thermal resistance and corrosion resistance as the outermost exposed layer of the mass damper 20.

According to another implementation of the present invention, the mass damper 20 may not be relied upon in forming the dimples 70 in the tube 14 as a result of the adjustment of the mass damper 20 from the open configuration to the closed configuration thereof. Instead, the dimples 70 may be pre-formed within the tube 14 via another manufacturing step occurring with respect to the tube 14, such as the use of a clamping mechanism having substantially the same structure and method of operation as the mass damper 20 as disclosed in FIGS. 4 and 5 in order to produce the dimples 70 to include the same configuration as would be expected via the closing of the mass damper 20 as described hereinabove, thereby ensuring a close fit and mating relationship present between the protuberances 38 of the mass damper 20 and the dimples 70 configured to receive such protuberances 38 therein. The mass damper 20 is thus able to be positioned axially along the tube 14 such that the protuberances 38 are guided into the dimples 70 upon the adjustment of the mass damper 20 from the open configuration to the closed configuration thereof while providing the same interference between the mass damper 20 and the tube 14 for delimiting the motion of the mass damper 20 relative to the tube 14. The resulting conduit assembly 10 may accordingly include the same interactions between the mass damper 20 and the tube 14 as depicted throughout FIGS. 4-6 despite the lack of deformation of the tube 14 via the mass damper 20 itself.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A mass damper for coupling to a tube, the mass damper comprising:
a first portion having a first tube receiving surface defining a first tube opening configured to partially receive the tube therein;
a second portion having a second tube receiving surface defining a second tube opening configured to partially receive the tube therein; and
at least one protuberance protruding from the first tube receiving surface and/or from the second tube receiving surface, each at least one protuberance configured to deform a corresponding dimple into an outer surface of the tube upon compression of the tube between the first tube receiving surface and the second tube receiving surface with each at least one protuberance received within each corresponding dimple to delimit movement of the mass damper relative to the tube.

2. The mass damper of claim 1, further comprising a hinge extending between and connecting the first portion to the second portion, the hinge forming a pivoting axis of each of the first portion and the second portion.

3. The mass damper of claim 2, wherein the first portion is comprised of a first core body and a first cover overlaying the first core body, wherein the second portion is comprised of a second core body and a second cover overlaying the second core body, and wherein the first cover, the second cover, and the hinge are formed as a monolithic structure.

4. The mass damper of claim 3, wherein the monolithic structure having the first cover, the second cover, and the hinge is formed during a process of overmolding the first core body and the second core body.

5. The mass damper of claim 3, wherein the first core body and the second core body are formed from a metallic material, and wherein the first cover, the second cover, and the hinge are formed from a polymeric material.

6. The mass damper of claim 2, wherein the mass damper is adjustable, via a pivoting of the first portion relative to the second portion about the pivoting axis, between an open configuration where each at least one protuberance has not yet formed or is not yet received within each corresponding dimple and a closed configuration where each at least one protuberance is received within each corresponding dimple.

7. The mass damper of claim 6, wherein an initial adjustment of the mass damper from the open configuration to the closed configuration thereof causes the compression of the tube between the first tube receiving surface and the second tube receiving surface for forming each corresponding dimple.

8. The mass damper of claim 6, wherein adjustment of the mass damper from the closed configuration back to the open configuration decouples the mass damper from the tube by removal of each at least one protuberance from each corresponding dimple, and wherein a subsequent adjustment of the mass damper back to the closed configuration thereof includes recoupling the mass damper to the tube via each at least one protuberance being received back within each corresponding dimple as previously formed upon initially coupling the mass damper to the tube.

9. The mass damper of claim 6, wherein the first portion includes a first snap fit feature and the second portion includes a second snap fit feature, and wherein adjustment of the mass damper from the open configuration to the closed configuration includes a snap-fit connection being formed between the first snap fit feature and the second snap fit feature to maintain the mass damper in the closed configuration.

10. The mass damper of claim 6, wherein the first portion includes a projection projecting therefrom and the second portion includes a hole formed therein, and wherein adjustment of the mass damper from the open configuration to the closed configuration includes a press-fit connection being formed between the projection and the hole to maintain the mass damper in the closed configuration.

11. The mass damper of claim 2, wherein the first tube receiving surface includes a semi-cylindrical shape as the first tube receiving surface extends arcuately from a first outer edge disposed towards the hinge to a second outer edge thereof disposed away from the hinge, wherein the at least one protuberance protrudes from the first tube receiving surface at an angular position along the semi-cylindrical shape that is biased towards the first outer edge and away from the second outer edge.

12. The mass damper of claim 1, wherein each at least one protuberance is tapered inwardly as each at least one protuberance protrudes away from the corresponding first tube receiving surface or second tube receiving surface.

13. The mass damper of claim 12, wherein each at least one protuberance includes a truncated pyramidal shape.

14. The mass damper of claim 1, wherein a height of each at least one protuberance measured in a radial direction of the tube is at least as great as a radial distance of separation of each at least one protuberance of the mass damper from a surface of the tube defining each corresponding dimple as caused by relative thermal expansion occurring between the mass damper and the tube in reaction to the tube being exposed to a maximum operating temperature and/or a minimum operating temperature.

15. The mass damper of claim 1, wherein the at least one protuberance includes a first protuberance protruding from the first tube receiving surface and received within a first dimple formed in the outer surface of the tube and a second protuberance protruding from the second tube receiving surface and received within a second dimple formed in the outer surface of the tube, wherein the first protuberance protrudes into the first dimple in a direction at least partially opposed to a direction the second protuberance protrudes into the second dimple.

16. A conduit assembly comprising:
at least one tube segment;
a mass damper coupled to the at least one tube segment, the mass damper comprising:
a first portion having a first tube receiving surface defining a first tube opening partially receiving the at least one tube segment therein;
a second portion including a second tube receiving surface defining a second tube opening configured to partially receive the at least one tube segment therein; and
at least one protuberance protruding from the first tube receiving surface and/or from the second tube receiving surface, each at least one protuberance configured to deform a corresponding dimple into an outer surface of the tube upon compression of the tube between the first tube receiving surface and the second tube receiving surface with each at least one protuberance received within each corresponding dimple to delimit movement of the mass damper relative to the tube.

17. The conduit assembly of claim 16, further comprising at least one hose coupled to an end of the at least one tube segment, the at least one hose having an outer surface formed from a polymeric material and the at least one tube segment having an outer surface formed from a metallic material, wherein a length of the at least tube segment is greater than a length of the at least one hose.

18. The conduit assembly of claim 17, wherein the conduit assembly is a suction A/C line connecting an outlet end of an evaporator of a refrigerant circuit to an inlet end of a compressor of the refrigerant circuit.

19. A method of coupling a mass damper to a tube comprising the steps of:
providing the mass damper, the mass damper including a first portion having a first tube receiving surface, a second portion having a second tube receiving surface, and at least one protuberance protruding from at least one of the first tube receiving surface and/or the second tube receiving surface;
disposing the tube between the first tube receiving surface and the second tube receiving surface; and
moving the first portion towards the second portion to cause the at least one protuberance to deform an outer surface of the tube to include a dimple therein, the dimple receiving the at least one protuberance therein to delimit movement of the mass damper relative to the tube.

20. The method of claim 19, wherein the first portion is pivotally connected to the second portion by a hinge extending therebetween, and wherein the moving of the first portion towards the second portion includes a pivoting of the first portion towards the second portion about a pivoting axis provided by the hinge.
